(19) United States
(12) Patent Application Publication
(10) Pub. No.: US 2006/0252372 A1
(43) Pub. Date: Nov. 9, 2006

(54) BLUETOOTH TRANSMISSION SYSTEM AND METHOD

(76) Inventors: Ming-Feng Liu, Taipei City (TW); Yi-Hung Shen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,589

(22) Filed: Aug. 9, 2005

(30) Foreign Application Priority Data
May 9, 2005 (TW) 94114849

(51) Int. Cl. H04B 7/00

(52) U.S. Cl. 455/41.2

(57) ABSTRACT

A Bluetooth transmission system and a Bluetooth transmission method are provided. The system utilizes an embedded controller with an independent power supply for setting up and storing a plurality of preset Bluetooth input devices. A Bluetooth module receives identification signals transmitted by the Bluetooth input devices and determine whether the identification signals contain a set of preset identification codes. According to the determination, the Bluetooth input device is connected to the controller. Next, a continuative action is executed in accordance with the received data which is transmitted by the Bluetooth input device.

### CROSS-REFERENCE TO RELATED APPLICATION

This application claims the priority benefit of Taiwan application serial no. 94114849, filed on May 9, 2005. All disclosure of the Taiwan application is incorporated herein by reference.

### BACKGROUND OF THE INVENTION

1. Field of Invention

The present invention relates to a Bluetooth transmission system and Bluetooth transmission method, and particularly to a Bluetooth transmission system and Bluetooth transmission method with an independent power supply.

2. Description of the Related Art

Currently, the Bluetooth transmission technique mainly uses a universal serial bus (USB) interface connecting to a host computer for wireless transmission. When a computer is turned on, a BIOS (basic input/output system) will be executed for testing first. Then, the operational system is entered into a Bluetooth driving program to call for a Bluetooth device.

Patent Official Gazette of R.O.C. No. I223156 discloses a “Method of Basic Input-Output System Supporting Bluetooth Equipment”, wherein the method is to add Bluetooth human interface device (HID) in BIOS to make the user of Bluetooth keyboard being able to directly use the HID under the computer booting mode or the DOS (disk operating system) mode to rapidly change the computer configuration without the Bluetooth driving program.

The drawback of the above-mentioned BIOS method is that to operate a Bluetooth keyboard for modifying a computer setting can be executed only when the computer is under the booting mode or after it is turned on. Such scheme requires a longer period of time and consumes more electricity, thus it is inconvenient for a user who only desires using some part of the computer functions.

One of the objects of the present invention is to provide a solution to the above-described problem.

### SUMMARY OF THE INVENTION

An object of the present invention is to provide a Bluetooth transmission system, wherein a Bluetooth module, by means of a controller with an independent power supply, receives data transmitted by a Bluetooth input device, so as to execute computer programs or modify computer settings when the computer system is turned off.

Another object of the present invention is to provide a Bluetooth transmission method, by which the corresponding Bluetooth input device can be identified by matching identification signals, so as to easily execute computer programs or modify computer settings.

The present invention provides a Bluetooth transmission system, comprising a Bluetooth input device for inputting data, a Bluetooth module to establish a wireless communication link with the Bluetooth input device for receiving the data, and a controller electrically connected to the Bluetooth module and a power supply. The power supply herein is used for supplying power to the controller so that the data can be downloaded from the Bluetooth module for executing a continuative action (see [0012], for consistency) on the computer system even when the computer system is turned off.

In a Bluetooth transmission system according to an embodiment of the present invention, the above-mentioned Bluetooth module further includes receiving an identification signal transmitted by a Bluetooth input device; if the identification signal contains a set of preset identification codes, the Bluetooth input device is linked to the controller.

According to an embodiment of the present invention, the Bluetooth transmission system further includes a switch electrically connected to the Bluetooth module for switching a transfer interface, and a converter electrically connected to the switch and the controller. The converter according to the switch status converts the transfer interface, which is used for transferring data.

In the Bluetooth transmission system according to an embodiment of the present invention, the above-mentioned controller is an embedded controller.

In the Bluetooth transmission system according to an embodiment of the present invention, the above-mentioned continuative actions include turning on/off the computer and starting to playback music with an audio device.

The present invention provides a Bluetooth transmission method, by which a Bluetooth input device is able to transmit data even when the computer is turned off. The method includes the following steps. First, a Bluetooth module receives an identification signal transmitted by a Bluetooth input device. Then, a controller decides whether the identification signal contains a set of preset identification codes or not. If the identification signal doesn't contain the preset identification codes, the Bluetooth module continues to receive a next identification signal; if the identification signal contains the preset identification codes, the Bluetooth module receives a data transmitted by the Bluetooth input device. Finally, the controller executes a continuative action on the computer system according to the data.

Since the present invention utilizes a controller with an independent power supply, the system is capable of executing computer programs or modifying the computer setting by a Bluetooth input device even when the computer is turned off, so that it reduces the consumption of time and electricity and increases convenience of faster operation.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a block diagram of a Bluetooth transmission system according to an embodiment of the present invention.

FIG. 2 is a flowchart of the Bluetooth transmission method according to an embodiment of the present invention.

FIG. 3 is a flowchart of the control method with Bluetooth keyboard hot keys according to an embodiment of the present invention.

FIG. 4 is a block diagram of another Bluetooth transmission system according to an embodiment of the present invention.

FIG. 5 is a block diagram of a further Bluetooth transmission system according to an embodiment of the present invention.

### DESCRIPTION OF THE EMBODIMENTS

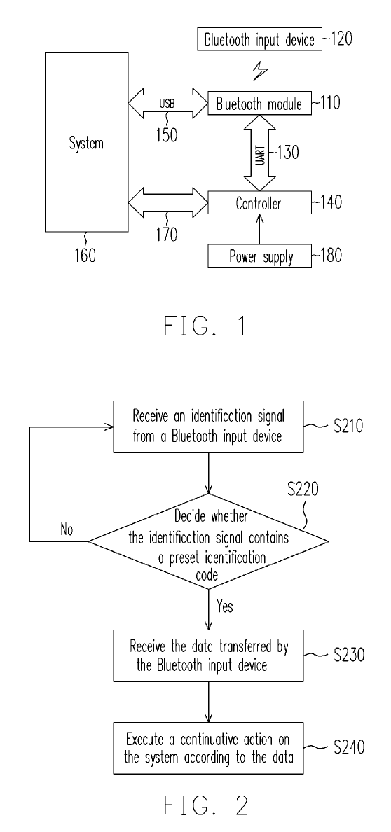

FIG. 1 is a block diagram of a Bluetooth transmission system according to an embodiment of the present invention. A Bluetooth module 110 detects and recognizes the identification signals transmitted by a Bluetooth input device 120. Wherein, the identification signals contain a preset identification code. According to the identification code, the Bluetooth module 110 establishes a link between the Bluetooth input device 120 and a controller 140. In addition, the Bluetooth input device 120 can download an input data through Bluetooth wireless transmission. Further, the downloaded data is transferred to the controller 140 by a UART (universal asynchronous receiver transmitter) 130 and to a system 160 by a USB (universal series bus) 150. The controller 140 is electrically connected to the Bluetooth module 110 and a power supply 180. The power supply 180 is used for providing power to the controller 140, so that to download the input data from the Bluetooth module 110 even when the computer is turned off. Once the controller 140 has received the input data, the controller is in conjunction with the system 160 through a connection interface 170 (for example, a bus). According to the input data, the system 160 will execute computer programs or modify computer settings. The controller is an embedded controller with an independent power supply; therefore, the controller is capable of implementing partial computer functions, such as turning on the computer or starting to playback music with an audio device even the system 160 is off. When the system 160 is on, the USB interface 150 or the connection interface 170 is available to connect the system for executing computer programs or modifying computer settings. While the system 160 is off, only the connection interface 170 is available for the controller 140 to connect the system 160 for implementing partial computer functions. In the present embodiment, the Bluetooth input device can be, but not limited to, a Bluetooth keyboard, a Bluetooth mouse, a Bluetooth cellular phone or a PDA (personal digital assistant); and the system 160 can be a computer. A user can, without departing from the scope or spirit of the invention, figure out a different application with the other configurations of Bluetooth input devices and systems to meet a specific need.

FIG. 2 is a flowchart of the Bluetooth transmission method according to an embodiment of the present invention. The method includes the following steps. First a Bluetooth module with a preset identification code receives an identification signal transmitted by a Bluetooth input device (step S210), wherein the identification signal contains an identification code. Then, it is decided whether the identification code contained in the identification signal is a preset identification code or not (step S220). If the identification signal doesn't contain the preset identification code, the Bluetooth module continues to receive next identification signal until an identification signal with the preset identification code is received; if the identification signal contains the preset identification code, a controller receives a data transmitted by the Bluetooth input device corresponding to the preset identification code (step S230). Finally, the data is interpreted and a continuative action requested by the data is executed (step S240). The above-mentioned continuative action includes, but not limited to, executing a computer program, modifying computer settings, turning on/off the computer or starting to playback music with an audio device. A user can apply to different continuative actions without departing from the scope or spirit of the invention.

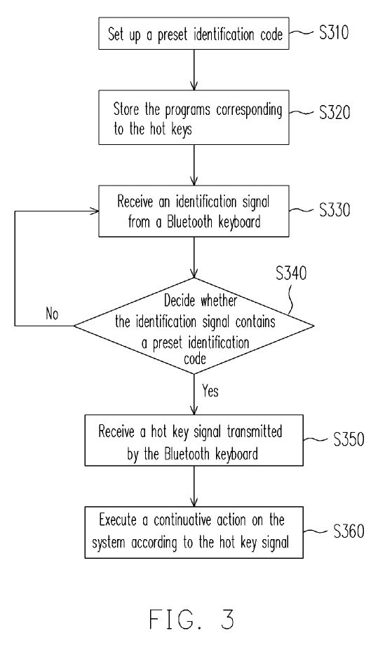

FIG. 3 is a flowchart of the control method with Bluetooth keyboard hot keys according to an embodiment of the present invention. The steps are described as follows. First, a Bluetooth keyboard is defined as a transmission interface and a preset identification code corresponding to the Bluetooth keyboard is stored (step S310). Then, the program codes corresponding to all hot keys on the Bluetooth keyboard are stored in the controller (step S320). Next, the Bluetooth module receives an identification signal from the Bluetooth keyboard (step S330). Further, the received identification signal is compared with the preset identification code (step S340). If the received identification signal doesn't contain the preset identification code, the Bluetooth module continues to receive next identification signal until an identification signal with the preset identification code is received; if the identification signal contains the preset identification code, the corresponding Bluetooth keyboard matching the preset identification code can be located. Then, a controller receives a hot key signal from the Bluetooth keyboard (step S350). After interpreting the hot key signal, a program code corresponding to the hot key is loaded. Finally, the continuative action instructed by the program code is implemented (step S360).

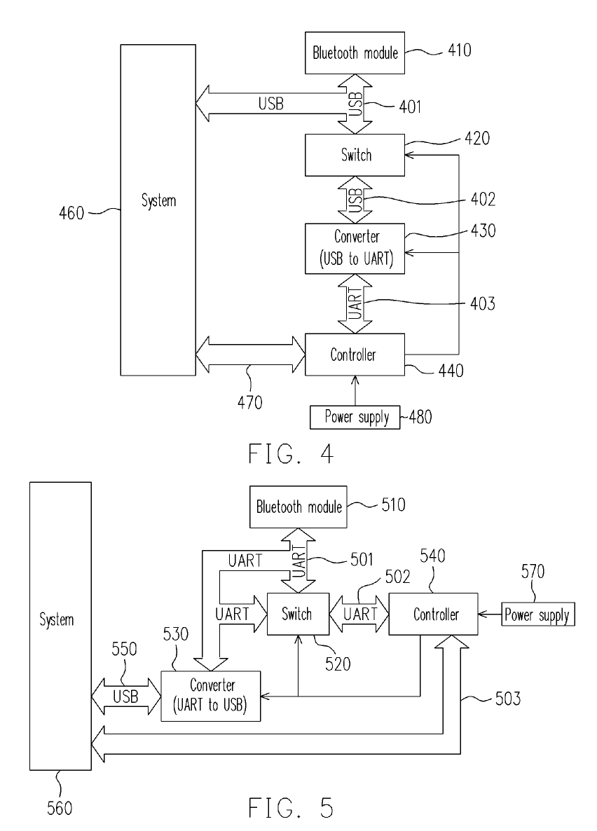

FIG. 4 is a block diagram of another Bluetooth transmission system according to an embodiment of the present invention. Wherein, a Bluetooth module 410, a controller 440, a system 460, a connection interface 470 and a power supply 480 have the same functions as the Bluetooth module 110, the controller 140, the USB interface 150, the system 160, the connection interface 170 and the power supply 180 in FIG. 1. The description is omitted. In the embodiment, a switch 420 and a converter 430 are added. The switch 420 is connected to the Bluetooth module 410 and the converter 430 through the USB interface 401 and the USB interface 402, respectively. The converter further connects to the controller 440 through a UART interface. After the Bluetooth module 410 has received data, it transmits the data through the USB interface 401 first. Alternatively, the Bluetooth module 410 can also, via the switch 420 and the converter 430, select a UART interface 403 to transmit the data to the controller. The switch 420 and the converter 430 control the switching via the controller 440 in advance for selecting a transfer interface.

FIG. 5 is a block diagram of a further Bluetooth transmission system according to an embodiment of the present invention. Wherein, a switch 520 is connected to a Bluetooth module 510, a converter 530 and a controller 540 through a UART interface 501 and a UART interface 502, respectively. The converter 530 is connected to a system 560 through a USB interface 550. The controller 540 is connected to the system 560 through a connection interface 503 and connected to a power supply 570. When the Bluetooth module 510 receives data, it will communicate with the controller 540 through the UART interface 501 and the UART interface 502, and transmit the data to the system 560 through a USB interface 550. The switch 520 and the converter 530 control the switching via the controller 540 in advance for selecting a data transfer interface. If the system 560 is on, the controller 540 is connected to the system 560 through the USB interface 550 or the connection interface 503 for executing computer programs or modifying computer settings on the system 560. While the system 560 is off, the controller 540 is connected to the system 560 through the connection interface 503 for executing partial computer functions on the system 560.

It can be seen from the above described that with the Bluetooth transmission system of the present invention a user is capable of manipulating the system for executing computer programs or modifying the computer settings by means of the Bluetooth input devices even the system is off. Consequently, the present invention significantly increases the convenience for a user to operate with a faster speed.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A Bluetooth transmission system, comprising:
a Bluetooth input device, used for inputting data;
a Bluetooth module, used to generate a link between the Bluetooth module and the Bluetooth input device for receiving the data; and
a controller, electrically connected to the Bluetooth module and a power supply; wherein the power supply provides electricity to the controller so that the data is able to be downloaded from the Bluetooth module even when a computer system is turned off; and then according to the data a continuative action on the computer system is executed.

2. The Bluetooth transmission system as recited in claim 1, wherein the Bluetooth module further comprises receiving an identification signal transmitted by the Bluetooth input device; and if the identification signal contains a preset identification code, the Bluetooth input device is linked with the controller.

3. The Bluetooth transmission system as recited in claim 1, wherein the Bluetooth input device is one of a Bluetooth keyboard, a Bluetooth mouse and a PDA (personal digital assistant).

4. The Bluetooth transmission system as recited in claim 1, further comprising:
a switch, electrically connected to the Bluetooth module for switching a transfer interface; and
a converter, electrically connected to the switch and the controller to convert transfer interfaces for transferring the data, wherein the transfer interface to be converted is selected by the switch.

5. The Bluetooth transmission system as recited in claim 4, wherein the transfer interfaces comprise a USB (universal series bus), and through the USB the Bluetooth module connects the computer system and transfers the input data.

6. The Bluetooth transmission system as recited in claim 4, wherein the transfer interfaces comprise a UART (universal asynchronous receiver transmitter), and through the UART the controller connects the Bluetooth module and transfers the input data.

7. The Bluetooth transmission system as recited in claim 1, wherein the controller is an embedded controller.

8. The Bluetooth transmission system as recited in claim 1, wherein the continuative action is turning on/off the computer system.

9. The Bluetooth transmission system as recited in claim 1, wherein the continuative action is starting a music playback device.

10. A Bluetooth transmission method, used for transmitting data by a Bluetooth input device when a computer system is turned off, comprising the following steps:
a. using a Bluetooth module to receive an identification signal transmitted by the Bluetooth input device;
b. using a controller to decide whether the identification signal contains a preset identification code or not, wherein
b1. if the identification signal does not contain the preset identification code, the Bluetooth module continues to receive identification signals;
b2. if the identification signal contains the preset identification code, the Bluetooth module receives the data transmitted by the Bluetooth input device; and
c. the controller executes a continuative action on the computer system according to the received data.

11. The Bluetooth transmission method as recited in claim 10, wherein the Bluetooth input device is one of a Bluetooth keyboard, a Bluetooth mouse and a PDA (personal digital assistant).

12. The Bluetooth transmission method as recited in claim 10, wherein the controller is an embedded controller.

13. The Bluetooth transmission method as recited in claim 10, wherein the continuative action is turning on/off the computer system.

14. The Bluetooth transmission method as recited in claim 10, wherein the continuative action is starting a music playback device.

15. The Bluetooth transmission method as recited in claim 10, wherein prior to step a, a step a1 is further comprised for setting up a hot key in the Bluetooth input device, and once the hot key is pressed down, the controller executes the continuative action corresponding to the hot key.
